(19) United States
(12) Patent Application Publication
(10) Pub. No.: US 2026/0233764 A1
(43) Pub. Date: Aug. 13, 2026

(54) DETERMINING OF SAFE ROAD SEGMENTS FOR AUTONOMOUS DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/458,954

(22) Filed: Jan. 26, 2026

Related U.S. Application Data
(60) Provisional application No. 63/756,827, filed on Feb. 11, 2025.

(51) Int. Cl. B60W 60/00; B60W 50/14; G06N 5/04

(52) U.S. Cl. CPC B60W 60/0053; B60W 50/14; G06N 5/04; B60W 2540/30; B60W 2552/53; B60W 2555/20

(57) ABSTRACT

The present disclosure provides a method for selective autonomous driving during inference. Method comprises determining, by a computerized system of a vehicle, that the vehicle is approaching a road segment that is deemed to be safe for autonomous driving according to a data structure currently stored in the vehicle. Method further comprises repetitively verifying by the computerized system, in real time, based on sensed information, that the road segment maintains safe. Method also comprises transferring a control over the vehicle to a human driver when facing a verification failure.

### CROSS-REFERENCE TO RELATED APPLICATIONS

This application claims priority to provisional patent U.S. Application No. 63/756,827 titled DETERMINING OF SAFE ROAD SEGMENTS FOR AUTONOMOUS DRIVING, filed Feb. 11 2025, which is hereby incorporated by reference in its entirety.

### FIELD OF INVENTION

The present disclosure relates to autonomous vehicle driving systems, and more particularly to methods and systems for determining and verifying safe road segments that enable intervention-free autonomous driving operations.

### BACKGROUND

Autonomous vehicles represent an evolving area of transportation technology that aims to reduce or eliminate the need for human driver intervention during vehicle operation. Various levels of autonomous driving have been defined, ranging from driver assistance systems that provide limited automated functions to fully autonomous systems capable of handling all driving tasks without human input.

Current autonomous driving systems often operate under the assumption that a human driver remains attentive and ready to assume control of the vehicle when prompted. These systems may require the driver to maintain visual attention on the road environment and keep their hands positioned on or near the steering wheel, even when automated driving functions are engaged. This requirement can limit the practical benefits of autonomous driving technology, as drivers cannot fully disengage from the driving task to engage in other activities.

The complexity of driving environments varies considerably across different road types and conditions. Urban areas with dense traffic, frequent intersections, pedestrian crossings, and unpredictable road user behavior present different challenges compared to highway segments with controlled access, consistent lane markings, and more predictable traffic patterns. Weather conditions, time of day, road construction, and other environmental factors further contribute to the variability in driving complexity.

Autonomous driving systems may employ various sensors, artificial intelligence models, and computational resources to perceive the driving environment and make driving decisions. The computational demands and sensor requirements for autonomous operation can vary depending on the complexity of the driving scenario being addressed. Systems designed to handle all possible driving scenarios may require substantial computational resources and sensor arrays.

There exists a general interest in developing approaches that can identify road segments where autonomous driving operations may be performed with reduced human driver attention or supervision. Such approaches may involve analyzing road characteristics, historical driving data, environmental conditions, and other factors to assess the suitability of particular road segments for various levels of autonomous operation.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for selective autonomous driving during inference is provided. Method comprises (i) determining, by a computerized system of a vehicle, that the vehicle is approaching a road segment that is deemed to be safe for autonomous driving according to a data structure currently stored in the vehicle, (ii) repetitively verifying by the computerized system, in real time, based on sensed information, that the road segment maintains safe, and (iii) transferring a control over the vehicle to a human driver when facing a verification failure.

According to another aspect of the present disclosure, a non-transitory computer readable medium storing instructions is provided. The instructions, when executed by a processor, cause the processor to (i) determine that the vehicle is approaching a road segment that is deemed to be safe for autonomous driving according to a data structure currently stored in the vehicle, (ii) repetitively verify by the computerized system, in real time, based on sensed information, that the road segment maintains safe, and (iii) transfer a control over the vehicle to a human driver when facing a verification failure.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart for a method for determination of safe road segments for autonomous driving, according to aspects of the present disclosure.

FIG. 2 illustrates a flowchart for a method for determination of safe road segments by semi-supervised learning, according to aspects of the present disclosure.

FIG. 3 illustrates a flowchart for a method for verification of safe road segments during inference, according to aspects of the present disclosure.

FIG. 4 illustrates an example of a computerized system used to generate a lane pilot, according to aspects of the present disclosure.

FIG. 5 illustrates an example of a vehicle configured to selectively apply lane pilot functionality for autonomous driving, according to aspects of the present disclosure.

FIG. 6 illustrates a diagram depicting a dense urban region and a highway straight lane, according to aspects of the present disclosure.

FIG. 7 illustrates a flowchart for a method.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems, non-transitory computer readable medium storing instructions, and methods for determining safe road segments for autonomous driving. The systems and methods described herein may provide several technical advantages over conventional approaches to autonomous driving and human-operated driving.

A Lane Pilot system implementing the disclosed techniques may deliver an “Eyes-Off, Hands-Off” driving experience for autonomous driving in a lane path. The Lane Pilot system may provide safe, predictable intervals, referred to as road segments, for intervention-free moments during which drivers may engage in other activities while the Lane Pilot system maintains control over a vehicle, ensuring a secure journey.

The technical benefits of the disclosed solution may include the ability to process and correlate multiple data streams simultaneously in a manner that exceeds human cognitive capabilities. A computerized system implementing the Lane Pilot system may continuously monitor and analyze sensor data from cameras, radar, lidar, and other sensing modalities while simultaneously cross-referencing this information against stored safe road segment data, real-time weather conditions, traffic patterns, and historical safety metrics. The human brain may be limited in its capacity to consciously process such diverse and voluminous data streams in parallel with the speed and consistency required for safe autonomous driving decisions.

The disclosed systems may perform repetitive verification operations at frequencies that may not be achievable through human attention and perception. For example, the computerized system may verify safety conditions tens or hundreds of times per second, comparing current sensed information against multiple safety thresholds and metrics with each verification cycle. Human drivers may experience attention lapses, fatigue, distraction, and variability in reaction times that may compromise the consistency of safety monitoring. The computerized system may maintain uniform vigilance and response characteristics regardless of time of day, duration of driving, or other factors that may affect human performance.

The disclosed techniques may enable integration of machine learning generated metrics with statistical metrics in a unified safety determination framework. The human brain may not be capable of simultaneously applying complex neural network inference operations alongside statistical calculations to generate composite safety assessments in real time. The computerized system may execute trained artificial intelligence models that have learned patterns from millions of driving scenarios while concurrently computing statistical measures derived from historical accident data, near-miss events, and other safety-relevant information.

The disclosed systems may access and query large-scale databases containing road segment information, safety classifications, and environmental data with latencies measured in milliseconds. Human memory and recall capabilities may not support the storage and rapid retrieval of detailed safety information for thousands or millions of road segments. The computerized system may maintain comprehensive data structures that encode safety determinations for road segments across diverse geographic regions and may update these data structures based on new information received through communication networks.

The semi-supervised learning processes described herein may identify clusters of safe road segments by matching evaluated road segments against additional road segments using similarity metrics and clustering algorithms. The computational complexity of these matching operations may scale with the number of road segments being analyzed, potentially involving comparisons across millions of data points. Human cognitive processes may not be suited to performing such large-scale pattern matching and cluster identification tasks with the precision and completeness achievable by the disclosed computerized systems.

The disclosed techniques may enable predictive notification capabilities that anticipate transitions between safe and non-safe road segments and provide timely alerts to human drivers. The computerized system may calculate the time and distance remaining until a safe road segment ends, accounting for current vehicle speed, traffic conditions, and driver response characteristics. Human drivers may not be able to maintain continuous awareness of upcoming road segment transitions while simultaneously attending to other driving-related or non-driving-related tasks.

The present disclosure relates to systems, non-transitory computer readable medium storing instructions, and methods for determining safe road segments for autonomous driving. A Lane Pilot system may deliver an “Eyes-Off, Hands-Off” driving experience for autonomous driving in a lane path. The Lane Pilot system may provide safe, predictable intervals, referred to as road segments, for intervention-free moments during which drivers may engage in other activities while the Lane Pilot system maintains control over a vehicle, ensuring a secure journey.

A lane path may include driving in any lane on a road, including highway travel, freeway travel, urban road travel, and the like. A single lane path may refer to driving in any lane on the road. A road segment that may be considered safe in the context of the Lane Pilot system may be a single-lane highway road segment. Any reference to a safe road segment may be interpreted as a reference to a safe single-lane highway segment.

A computerized system implementing the Lane Pilot system may be a compact and power saving system configured to operate on a relatively specific task of autonomous driving. For example, the Lane Pilot system may be configured to operate on a relatively specific task of road lane driving. An artificial intelligence model operation of the computerized system may exhibit low compute consumption. Providing respective sets of safe road segments for lane roads may allow for low compute consumption and usage of a minimal number of sensors for autonomous driving in lane roads.

The Lane Pilot system may operate during road segments that are deemed safe and may deactivate during road segments that are not deemed to be safe. By limiting usage of the Lane Pilot system to specific scenarios related to road segments that are deemed to be safe, the Lane Pilot system may involve executing autonomous driving operations that are verified and tested to be safe and executable by a mature artificial intelligence model. The Lane Pilot system may guarantee the safety of autonomous driving even without human driver attention or supervising by limiting usage to specific scenarios deemed to be safe.

An example for determining safe road segments is illustrated in U.S. Pat. No. 12,415,547, which is incorporated herein by reference in its entirety. road segments may be deemed to be safe for autonomous driving based on scenarios associated with the road segments or not based upon scenarios. Safety may be tested by actually performing at least a defined number of autonomous driving sessions and experiencing up to a tolerable value of errors.

A road segment may be deemed safe for autonomous driving based on historical data and statistics. The historical data may include accident statistics collected from insurance records, police reports, government transportation databases, and other sources. The historical data may also include near accident statistics that capture incidents where collisions were narrowly avoided. Road segments with lower accident rates and near accident rates over a defined time period may be more likely to be classified as safe road segments. In some aspects, road segments may be ranked according to accident frequency per vehicle mile traveled, and road segments falling below a threshold accident rate may be deemed safe.

A road segment may be deemed safe based on complexity of driving associated with the road segment. Complexity factors may include the number of lanes, frequency of lane changes required, presence of merging traffic, intersection density, pedestrian crossing frequency, and variability in speed limits. Road segments with lower complexity scores may be more suitable for autonomous driving operations. In some cases, autonomous vehicle guidelines published by regulatory bodies or industry organizations may define complexity thresholds that road segments should satisfy to be deemed safe for various levels of autonomous operation.

Situations may be determined to be safe based on successful testing. Testing a situation to be safe for autonomous driving may involve actually driving through the situation using an autonomous vehicle and evaluating whether the autonomous driving was performed safely. Testing may also involve processing sensed information acquired from a vehicle while driving through the situation. Testing may further involve simulating the driving through the situation using a simulation environment. Testing may involve a combination of actual driving and simulation. Testing may involve any type of evaluation that assesses whether autonomous driving can be safely performed in the situation.

Alternatively, a situation may be deemed to be safe if at least a predefined number of similar situations were successfully tested. For example, if a threshold number of similar situations have been tested and found to be safe for autonomous driving, an untested situation that is similar to the tested situations may also be deemed safe. The predefined number may be configured based on desired confidence levels and risk tolerance.

Similar situations may be defined by using any similarity test and similarity test rules. A similarity test may compare characteristics of situations to determine whether they are sufficiently alike. Similarity test rules may specify which parameters to compare and what degree of similarity is required. The similarity test may use distance metrics, clustering algorithms, or other techniques to assess similarity between situations.

A group of scenarios may be represented by scenario signatures that represent the scenarios and belong to a certain cluster of signatures. Signatures may be generated in any manner, including the manners illustrated elsewhere in the present disclosure. A scenario signature may encode relevant characteristics of a scenario in a format suitable for comparison and clustering operations.

If a predefined number or a predefined percent of the situations in a cluster are tested to be safe, or otherwise declared to be safe, the entire scenarios of the certain cluster may be deemed to be safe, even if not all have been actually tested. Thus, some but not all of the scenarios of the cluster may be selected in any manner and are tested for safe autonomous driving, and if succeeding then all the cluster members may be deemed to be safe. This approach may reduce the testing burden while still providing confidence in the safety of untested scenarios within the cluster.

Multiple clusters that include situations may be virtually linked to each other in the sense that a group of clusters may be specific examples of a larger cluster. Once all of the members of the group are safe, the larger cluster may be regarded safe as well. This hierarchical relationship between clusters may enable efficient propagation of safety determinations across related scenarios.

When searching whether an untested scenario is similar to another scenario known or assumed to be safe, the other scenario should not be riskier than the untested scenario. One or more risk factors may include illumination, where darker environments may be deemed to be riskier than more illuminated scenarios. On the other hand, driving in a scenario that is too bright, for example when the sun may blind the driver, may also be riskier than slightly darker scenarios. Risk factors may include traffic load, where driving over an empty lane may be less risky than driving in a heavily crowded lane. Risk factors may include weather conditions such as visibility, rain, snow, and ice.

Similar scenarios may differ from each other by at least one parameter that defines the situation. For example, similar scenarios may differ from each other by at least one of a location of the vehicle, one or more weather conditions, one or more contextual parameters, a road condition, a traffic parameter, and a potential risk.

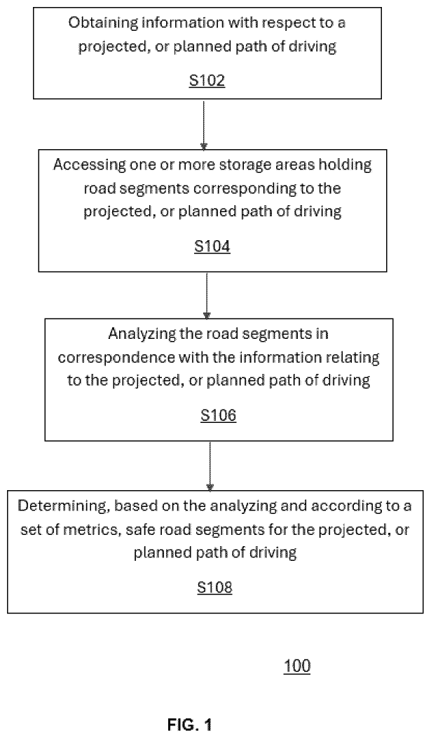

Referring to FIG. 1, a method 100 for determination of safe road segments for autonomous driving is illustrated. Method 100 may be implemented using an artificial intelligence model that is trained to identify or determine safe road segments for autonomous driving. The artificial intelligence model may be implemented using a machine learning process, a neural network, or an analytical or statistical model. Method 100 may be executed by a processing system comprising one or more central processing units, graphics processing units, tensor processing units, or application-specific integrated circuits configured for machine learning inference operations. The processing system may include a multi-core processor architecture with dedicated cores allocated for sensor data processing, neural network inference, and vehicle control operations.

Method 100 begins at step 102, where information is obtained with respect to a projected or planned path of driving. The information obtained at step 102 may include route data, destination information, and other parameters associated with an intended driving path of a vehicle. The information may be obtained from a global positioning system receiver configured to receive satellite signals and determine vehicle position coordinates. The global positioning system receiver may include a multi-band antenna capable of receiving signals from multiple satellite constellations including GPS, GLONASS, Galileo, and BeiDou. The information may also be obtained from an inertial measurement unit comprising accelerometers and gyroscopes configured to measure vehicle acceleration and angular velocity along three orthogonal axes. A navigation module may fuse position data from the global positioning system receiver with motion data from the inertial measurement unit using a Kalman filter or particle filter algorithm to generate accurate vehicle position and heading estimates.

Method 100 proceeds to step 104, where one or more storage areas holding road segments corresponding to the projected or planned path of driving are accessed. The storage areas containing the road segments may be maintained in the cloud. The road segments may be maintained in one or more databases and stored together with, or separately from, the system or trained artificial intelligence models. The databases may be held in association with the trained artificial intelligence models, or autonomously from the trained artificial intelligence models, for example at a third party. The storage areas may comprise solid-state drives, hard disk drives, or flash memory devices configured to store road segment data in a structured format. The storage areas may include non-volatile memory such as NAND flash memory or NOR flash memory for persistent storage of road segment information. The storage areas may also include volatile memory such as dynamic random-access memory or static random-access memory for caching frequently accessed road segment data during driving operations. A database management system may organize the road segment data using relational database structures, graph database structures, or key-value store structures optimized for spatial queries and geographic lookups.

With continued reference to FIG. 1, method 100 continues to step 106, where the road segments are analyzed in correspondence with the information relating to the projected or planned path of driving. The analysis at step 106 may involve comparing characteristics of the road segments against the driving path information obtained at step 102. The analysis may be performed by a dedicated analysis module executing on the processing system. The analysis module may implement spatial indexing algorithms such as R-tree indexing, quadtree indexing, or geohash indexing to efficiently identify road segments that intersect with the projected driving path. The analysis module may retrieve road segment attributes including segment length, curvature values, lane width measurements, speed limit designations, and historical safety metrics from the storage areas.

Method 100 then proceeds to step 108, where safe road segments for the projected or planned path of driving are determined based on the analyzing and according to a set of metrics. A road segment may be deemed to be safe based on multiple metrics. The multiple metrics may include a machine learning generated metric and a statistical metric. The multiple metrics may include at least one of general-purpose metrics, system-specific metrics, driving related metrics, road related metrics, environmental metrics, and key performance indicators. The metrics may be determined respectively to a particular path of driving, defined for similar types of road segments, or determined in general, or any combination thereof. The determination at step 108 may be performed by a metric evaluation engine comprising a plurality of metric calculators, each metric calculator configured to compute a respective metric value for a road segment. The metric evaluation engine may aggregate the computed metric values using a weighted scoring function, a decision tree classifier, or a neural network classifier to generate a final safety determination for each road segment. The metric evaluation engine may store the safety determinations in a results buffer implemented in random-access memory for subsequent retrieval by downstream processing modules.

Determination or identification of a safe road segment may use a neural network that was trained to identify safe road segments. Determination or identification of a safe road segment may also use a statistical model that predicts upcoming safe road segments based on collected data. A non-transitory computer readable medium storing instructions that, when executed by a processor, cause the processor to perform method 100 may determine that a road segment is deemed to be safe based on multiple metrics. The multiple metrics stored or processed by the non-transitory computer readable medium may include a machine learning generated metric and a statistical metric. The multiple metrics may include at least one of general-purpose metrics, system-specific metrics, driving related metrics, road related metrics, environmental metrics, and key performance indicators. The neural network may comprise a convolutional neural network architecture with multiple convolutional layers, pooling layers, and fully connected layers configured to process road segment feature vectors. The neural network may alternatively comprise a recurrent neural network architecture with long short-term memory cells or gated recurrent units configured to process sequential road segment data along a driving path. The neural network may be implemented using a deep learning framework executing on a graphics processing unit or tensor processing unit optimized for parallel matrix multiplication operations.

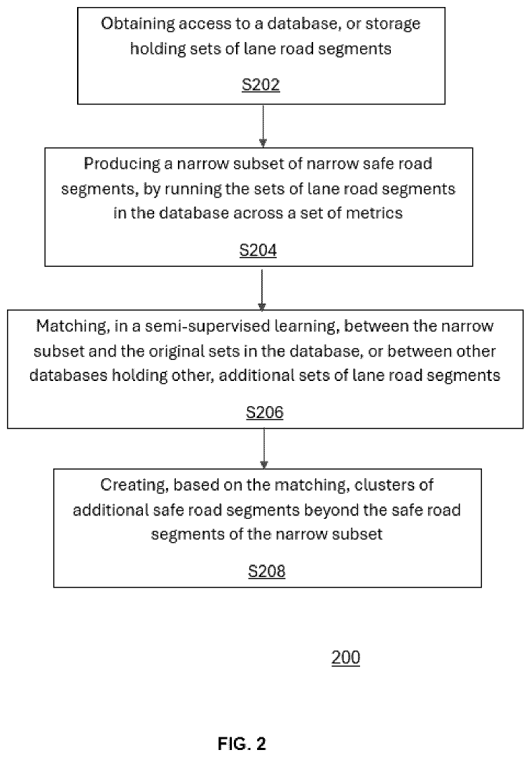

Referring to FIG. 2, a method 200 for determination of safe road segments by semi-supervised learning is illustrated. Method 200 may be used to populate a data structure by evaluated road segments that are found to be safe by applying multiple metrics, and by similar road segments that are found by training a machine learning model to provide road segments deemed to be safe. The training may comprise applying a semi-supervised learning process that matches the evaluated road segments against additional road segments to identify clusters of safe road segments. Method 200 may be executed on a distributed computing infrastructure comprising multiple server nodes interconnected by a high-bandwidth network fabric. Each server node may include multiple processors, multiple graphics processing units, and high-capacity memory modules configured for large-scale machine learning training operations. The distributed computing infrastructure may implement a parameter server architecture or an all-reduce architecture for synchronizing model parameters across the multiple server nodes during training.

Method 200 begins at step 202, where access is obtained to a database or other storage holding sets of lane road segments. The database may store various recordings collected in highways based on GPS and maps, or based on environmental elements such as signs, lane marks, and road structures. The database may be implemented using a distributed database system comprising multiple storage nodes configured for horizontal scaling and fault tolerance. The distributed database system may implement data replication across multiple geographic regions to ensure data availability and reduce access latency. The database may store road segment data in a columnar storage format optimized for analytical queries and batch processing operations. A data ingestion pipeline may continuously receive new road segment recordings from a fleet of vehicles equipped with data collection sensors and upload the recordings to the database through a message queue system.

With continued reference to FIG. 2, method 200 proceeds to step 204, where a narrow subset of safe road segments is produced by running the sets of lane road segments in the database across a set of metrics. The highway may be split into intervals of at least a defined number N1 of kilometers, wherein N1 may equal the product of a duration of a non-eye session multiplied by an average speed during the non-eye session. For example, to support 5 minutes eyes off at 90 kilometers per hour, intervals of 7.5 kilometers may be used. The highway segment may include a substantially straight lane with low curvatures and no lane split or merge from a right lane. The metric evaluation at step 204 may be performed by a batch processing system configured to process large volumes of road segment data in parallel. The batch processing system may implement a MapReduce programming model or a dataflow programming model to distribute metric calculations across multiple processing nodes. Each processing node may execute metric calculation tasks on assigned partitions of the road segment data and aggregate results to produce the narrow subset of safe road segments.

Out of the datasets of intervals, a subset of samples of safe road segments may be collected based on specific conditions. The specific conditions may include weather conditions such as clear weather, day, night, and light rain. The specific conditions may include clear lane marking. The specific conditions may include road edge greater than x meters. The specific conditions may include no animals or pedestrians crossing. The specific conditions may include no accidents, hazards, or obstacles on the road. The condition evaluation may be performed by a rule engine configured to evaluate Boolean expressions representing the specific conditions against road segment attributes. The rule engine may implement a forward-chaining inference mechanism or a backward-chaining inference mechanism to determine whether each road segment satisfies all specified conditions.

Method 200 continues to step 206, where matching is performed in a semi-supervised learning process between the narrow subset and the original sets in the database, or between other databases holding other additional sets of lane road segments. The subset of safe road segments may be matched with an untagged subset to generate enough samples for each type of cluster. Examples of clusters may include road segments in 2, 4, 6, or 8 lane highways for each direction, and any combination of speed limit and urban or rural highways. The semi-supervised learning process may implement a label propagation algorithm, a self-training algorithm, or a co-training algorithm to extend safety labels from the narrow subset to unlabeled road segments. The matching may utilize a feature extraction module configured to generate feature embeddings for each road segment using an autoencoder neural network or a variational autoencoder neural network. The feature embeddings may be stored in a vector database optimized for similarity search operations using approximate nearest neighbor algorithms such as locality-sensitive hashing or hierarchical navigable small world graphs.

As further shown in FIG. 2, method 200 proceeds to step 208, where clusters of additional safe road segments beyond the safe road segments of the narrow subset are created based on the matching. Statistical inferences may be made from all clusters in the database and unsupervised machine learning may be used to automatically build a model that is able to identify safe road segments. The clustering at step 208 may be performed by a clustering module implementing k-means clustering, hierarchical clustering, density-based spatial clustering, or Gaussian mixture model clustering algorithms. The clustering module may execute on a graphics processing unit configured to accelerate distance calculations and cluster assignment operations. The clustering module may store cluster assignments and cluster centroids in a cluster metadata store for subsequent retrieval during inference operations.

The clusters of safe road segments created at step 208 may include safe highway cluster segments, safe urban lane cluster segments, safe road night cluster segments, safe road day time cluster segments, safe road clear day cluster segments, and safe road tunnel cluster segments. A neural network may be trained in one or more manners including supervised and semi-supervised learning to identify safe road segments within the clusters. The neural network training may utilize a training pipeline comprising data preprocessing stages, model training stages, and model validation stages. The data preprocessing stages may implement data augmentation techniques, feature normalization techniques, and data balancing techniques to improve model generalization. The model training stages may implement stochastic gradient descent optimization, Adam optimization, or RMSprop optimization with learning rate scheduling and early stopping regularization. The model validation stages may implement cross-validation techniques and holdout validation techniques to assess model performance on unseen data.

A non-transitory computer readable medium storing instructions that, when executed by a processor, cause the processor to perform method 200 may populate a data structure by evaluated road segments that are found to be safe by applying multiple metrics, and by similar road segments that are found by training a machine learning model to provide road segments deemed to be safe. The training performed by the non-transitory computer readable medium may comprise applying a semi-supervised learning process that matches the evaluated road segments against additional road segments to identify clusters of safe road segments. The non-transitory computer readable medium may comprise a solid-state drive, a hard disk drive, a flash memory device, or an optical disc configured to store executable instructions in a persistent manner. The non-transitory computer readable medium may store the instructions in a compiled binary format, an intermediate bytecode format, or an interpreted script format compatible with the processor architecture.

A road segment may be determined as a safe road segment on a temporary basis. A computerized system may be configured to change a determination of a road segment deemed to be safe to unsafe at any point of time, in training or during inference, and conditional or depending on changing system requirements, road conditions, driving behaviors, and other considerations. For example, the computerized system may be configured to change a determination of a safe road segment when detecting during driving, or in test time, anomalies, or the identification of existing or new hazards over the road segment that may indicate that the particular road segment is not safe, for example, upon detection of obstacles that did not appear before in the road segment. The computerized system may implement a safety status update module configured to receive hazard notifications from external sources and update road segment safety determinations in real time. The safety status update module may subscribe to a publish-subscribe messaging system that distributes hazard notifications from traffic management centers, emergency services, and other vehicles.

A safe road segment may be defined in one or more manners and by one or more entities. A safe road segment may be selected manually. A safe road segment may be detected based on analysis of information regarding the road segment. A safe road segment may be communicated to a vehicle using vehicle to vehicle communication. A safe road segment may be detected based on analysis of behaviors of road users of the road segment. The vehicle to vehicle communication may be implemented using dedicated short-range communication transceivers operating in the 5.9 GHz frequency band or cellular vehicle-to-everything transceivers operating in licensed cellular frequency bands. The vehicle to vehicle communication may implement message authentication and encryption protocols to ensure the integrity and confidentiality of safety-related messages.

A safe road segment may have a complexity below a specified complexity threshold. A safe road segment may be associated with a risk below a specified risk threshold. The complexity threshold and the risk threshold may be used as metrics for determining whether a road segment qualifies as safe for autonomous driving operations. The complexity threshold and the risk threshold may be stored in a configuration database accessible by the processing system. The configuration database may support dynamic threshold adjustment based on vehicle capabilities, driver preferences, and regulatory requirements.

A safe road segment may be determined based on collected behavioral information of road users such as vehicles or pedestrians at the road segments. A risky behavior may involve or cause an abrupt change of speed and/or direction. Abrupt may mean that a rate of change of speed or direction exceeds a defined threshold and/or exceeds by at least 50 percent an average rate of change. Road segments where road users exhibit risky behaviors may be excluded from classification as safe road segments. The behavioral information may be collected by a behavior analysis module configured to process trajectory data from multiple road users over time. The behavior analysis module may implement trajectory prediction algorithms using recurrent neural networks or transformer neural networks to identify anomalous movement patterns indicative of risky behaviors.

A safe road segment may be determined based on accidents statistics and/or near accident statistics. The accidents statistics and near accident statistics may be gathered from one or more sources such as insurance records, police reports, and information gathered from social media. Road segments with elevated accident or near accident statistics may be excluded from classification as safe road segments. The statistics may be stored in a statistics database configured to aggregate accident data from multiple sources and compute statistical metrics for each road segment. The statistics database may implement time-series analysis algorithms to identify trends in accident rates and detect road segments with increasing risk profiles.

Road segments may be sorted according to risk related information and a defined number or percentile of lowest risk may be deemed to be safe. For example, road segments may be ranked from lowest risk to highest risk, and a bottom percentile of road segments with the lowest risk values may be classified as safe road segments. The sorting and ranking may be performed by a ranking module configured to implement sorting algorithms optimized for large datasets. The ranking module may utilize external merge sort algorithms or distributed sorting algorithms to process road segment risk data that exceeds available memory capacity.

A safety level of a road segment may be time dependent and/or event dependent. The safety level may be determined on an hourly basis, on a day of the week, holidays, weekends, a combination of time and day, near a school, or near an amphitheater. A road segment that is deemed safe during certain time periods may not be deemed safe during other time periods based on varying traffic patterns, pedestrian activity, or other time-dependent or event-dependent factors. The time-dependent safety determination may be implemented by a temporal analysis module configured to maintain separate safety profiles for different time periods. The temporal analysis module may access a real-time clock and a calendar database to determine the current time period and retrieve the corresponding safety profile for each road segment.

The multiple metrics used to determine whether a road segment is deemed to be safe may comprise one or more metrics related to durations of non-interrupted autonomous driving sessions over the road segment. A method for selective autonomous driving during inference may determine that a road segment is deemed to be safe based on multiple metrics that comprise one or more metrics related to durations of non-interrupted autonomous driving sessions over the road segment. A non-transitory computer readable medium storing instructions that, when executed by a processor, cause the processor to perform a method for selective autonomous driving during inference may determine that a road segment is deemed to be safe based on multiple metrics that comprise one or more metrics related to durations of non-interrupted autonomous driving sessions over the road segment. Road segments where autonomous driving sessions have been completed without interruption for extended durations may be more likely to be classified as safe road segments. The duration metrics may be computed by a session tracking module configured to record the start time, end time, and interruption events for each autonomous driving session. The session tracking module may store session records in a session database and compute aggregate duration statistics for each road segment.

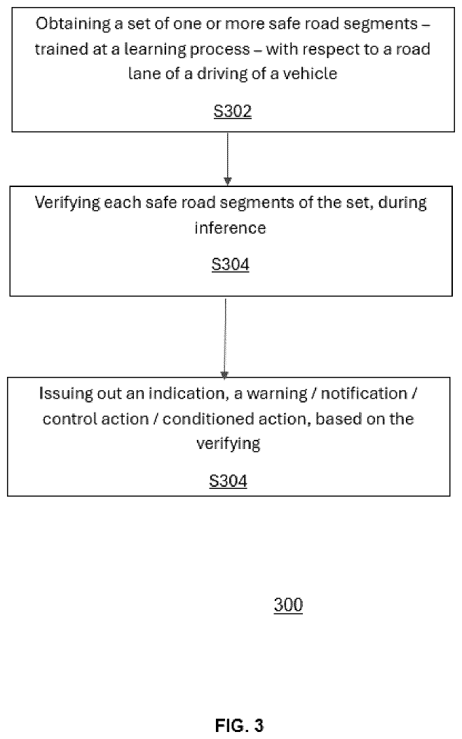

Referring to FIG. 3, a method 300 for verification of safe road segments during inference is illustrated. Method 300 may be used for selective autonomous driving during inference. A non-transitory computer readable medium storing instructions that, when executed by a processor, cause the processor to perform method 300 for selective autonomous driving during inference may be provided. Method 300 may be executed by an embedded processing system installed in a vehicle and configured for real-time operation with deterministic timing guarantees. The embedded processing system may implement a real-time operating system configured to schedule verification tasks with bounded latency and guaranteed execution deadlines.

Method 300 begins at step 302, where a set of one or more safe road segments is obtained. The set of safe road segments may be trained at a learning process with respect to a road lane of a driving of a vehicle. The set of safe road segments with respect to a road lane may be obtained offline at path planning before driving, or in real time driving. Road lanes may be associated with respective sets of safe road segments. For example, a first set of safe road segments may be associated with a first road lane, and a second set of safe road segments may be associated with a second road lane. The safe road segment data may be retrieved from a local storage device installed in the vehicle or downloaded from a remote server through a wireless communication link. The local storage device may comprise an automotive-grade solid-state drive or embedded multimedia card configured to operate reliably across a wide temperature range and withstand vibration and shock conditions encountered during vehicle operation.

A computerized system of a vehicle may determine that the vehicle is approaching a road segment that is deemed to be safe for autonomous driving according to a data structure currently stored in the vehicle. The data structure may contain the set of safe road segments obtained at step 302. A non-transitory computer readable medium storing instructions that, when executed by a processor, cause the processor to determine that a vehicle is approaching a road segment that is deemed to be safe for autonomous driving according to a data structure currently stored in the vehicle may be provided. The determination may be performed by a proximity detection module configured to compare the current vehicle position against the geographic boundaries of safe road segments stored in the data structure. The proximity detection module may implement geofencing algorithms to detect when the vehicle enters or exits the geographic boundaries of each safe road segment.

With continued reference to FIG. 3, method 300 proceeds to step 304, where each safe road segment of the set is verified during inference. The computerized system may repetitively verify, in real time, based on sensed information, that the road segment maintains safe. A non-transitory computer readable medium storing instructions that, when executed by a processor, cause the processor to repetitively verify, in real time, based on sensed information, that the road segment maintains safe may be provided. The verification may be performed at a configurable verification frequency, such as 10 times per second, 20 times per second, or 50 times per second, depending on vehicle speed and road segment characteristics. The verification module may implement a state machine with states corresponding to verified safe, verification pending, and verification failed, with transitions triggered by sensor data analysis results.

The verifying at step 304 may be based on real time conditions related to the road segment. The real-time conditions may comprise at least one of weather conditions, road hazards, road barriers, anomalies on the road, and unexpected lane merges or lane splits. A non-transitory computer readable medium storing instructions that, when executed by a processor, cause the processor to verify based on real time conditions related to the road segment may be provided. The real-time conditions processed by the non-transitory computer readable medium may comprise at least one of weather conditions, road hazards, road barriers, anomalies on the road, and unexpected lane merges or lane splits. The weather conditions may be detected by a weather sensing module comprising a rain sensor, a temperature sensor, a humidity sensor, and a visibility sensor configured to measure ambient weather parameters. The weather sensing module may also receive weather data from external weather services through a cellular communication link or a satellite communication link.

The verifying at step 304 may involve matching between each safe road segment and a set of real time conditions. The matching may include identifying or receiving an indication for an upcoming road segment that is marked as a safe road segment. The matching may include obtaining sensed information pertaining to a real time driving scenario. The sensed information may comprise at least one of road condition information, driving behavioral information of road players in a road lane, environmental information, and information pertaining to road barriers and hazards. A non-transitory computer readable medium storing instructions that, when executed by a processor, cause the processor to obtain sensed information may be provided. The sensed information obtained by the non-transitory computer readable medium may comprise at least one of road condition information, driving behavioral information of road players in a road lane, environmental information, and information pertaining to road barriers and hazards. The sensed information may be obtained from a sensor fusion module configured to combine data from multiple sensor modalities including cameras, radar sensors, lidar sensors, and ultrasonic sensors. The sensor fusion module may implement early fusion, late fusion, or mid-level fusion architectures to generate a unified environmental representation from the multi-modal sensor data.

The sensed information may include road players in the road lane, road barriers, hazards, and anomalies. The matching may include analyzing the sensed information to determine across a set of conditions whether the conditions are met. The matching may include matching the set of conditions for each road segment that is marked as a safe road segment. The verification may confirm that there is no heavy rain or snow. The verification may confirm that there is no hazard, road barrier, or other anomaly on the road. The verification may confirm that there is no unexpected lane merge or lane split within a target interval. The condition matching may be performed by a condition evaluation engine configured to evaluate Boolean predicates against the sensed information. The condition evaluation engine may implement short-circuit evaluation to optimize condition checking performance and reduce computational overhead.

As further shown in FIG. 3, method 300 includes issuing an indication, a warning, a notification, a control action, or a conditioned action based on the verifying at step 304. The computerized system may transfer a control over the vehicle to a human driver when facing a verification failure. A non-transitory computer readable medium storing instructions that, when executed by a processor, cause the processor to transfer a control over the vehicle to a human driver when facing a verification failure may be provided. The control transfer may be managed by a handoff controller configured to coordinate the transition of vehicle control from the autonomous driving system to the human driver. The handoff controller may implement a graduated handoff protocol that progressively increases driver engagement requirements before completing the control transfer.

The computerized system may issue a control action conditioning activation of a lane pilot system of the vehicle across each safe road segment based on the verifying. The computerized system may issue, by the computerized system, a predictive indication notification to the human driver prior to a transition. The predictive indication notification may be issued 5 to 10 seconds before the driver is to take control over the driving. The computerized system may selectively deactivate a safe road segment driving module upon the transition. A non-transitory computer readable medium storing instructions that, when executed by a processor, cause the processor to issue a predictive indication notification to the human driver prior to the transition, and selectively deactivate a safe road segment driving module upon the transition may be provided. The predictive indication notification may be generated by a notification generation module configured to produce audio notifications, visual notifications, and haptic notifications. The audio notifications may be output through vehicle speakers or a driver headset. The visual notifications may be displayed on an instrument cluster display, a head-up display, or a center console display. The haptic notifications may be delivered through a vibrating steering wheel, a vibrating seat, or a vibrating seatbelt tensioner.

The predictive indication notification may be issued based on the verification, for example if the verification of a safe road segment failed in real time. The predictive indication notification may be issued based on the verifying during or before a transition between a safe road segment and a non-safe road segment. The timing of the predictive indication notification may be determined by a notification timing module configured to calculate the required lead time based on current vehicle speed, driver attention state, and road segment transition distance. The notification timing module may adjust the lead time dynamically based on driver response patterns observed during previous transitions.

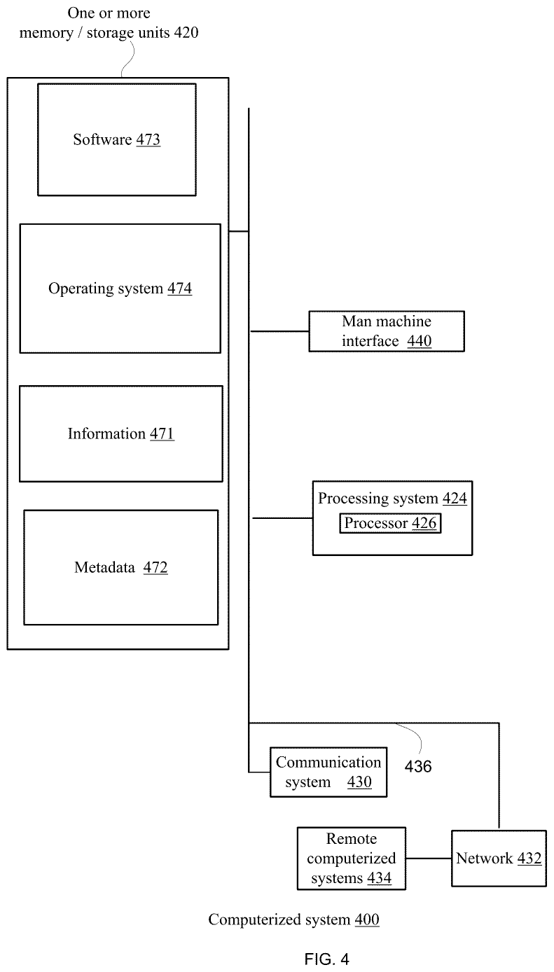

Referring to FIG. 4, a computerized system 400 used to generate the lane pilot is illustrated. The computerized system 400 may include one or more memory/storage units 420, a processing system 424 including a processor 426, a communication system 430, and a man machine interface 440. The computerized system 400 may be implemented as a rack-mounted server, a blade server, a tower server, or a workstation computer configured for machine learning model development and training operations.

The processor 426 may include a plurality of processing units. The plurality of processing units may operate in parallel or in coordination to execute software and perform operations associated with determination of safe road segments for autonomous driving. The processor 426 may comprise a multi-core central processing unit with 8, 16, 32, or 64 processing cores configured for parallel execution of software threads. The processor 426 may implement simultaneous multithreading to execute multiple threads per processing core. The processor 426 may include multiple levels of cache memory including L1 instruction cache, L1 data cache, L2 unified cache, and L3 shared cache to reduce memory access latency. The processing system 424 may also include one or more graphics processing units comprising thousands of streaming multiprocessors configured for parallel execution of compute kernels. The graphics processing units may include high-bandwidth memory providing memory bandwidth exceeding 1 terabyte per second for data-intensive machine learning operations.

With continued reference to FIG. 4, the memory/storage units 420 may store software 473, an operating system 474, information 471, and metadata 472. The software 473 may be stored at a top portion of the memory/storage units 420. The operating system 474 may be positioned below the software 473. The information 471 may be stored beneath the operating system 474. The metadata 472 may be stored at a bottom portion of the memory/storage units 420. The processing system 424 may be configured to perform method 100, method 200, or method 300 while executing the software 473. The memory/storage units 420 may comprise dynamic random-access memory modules providing 64 gigabytes, 128 gigabytes, 256 gigabytes, or 512 gigabytes of system memory. The memory/storage units 420 may also comprise solid-state drives providing 1 terabyte, 2 terabytes, 4 terabytes, or 8 terabytes of persistent storage capacity. The memory/storage units 420 may implement error-correcting code memory to detect and correct single-bit errors and detect multi-bit errors in stored data.

The communication system 430 may be connected to the processing system 424 via a communication link 436. The communication system 430 may provide connectivity to a network 432 and to remote computerized systems 434. The remote computerized systems 434 may also be connected to the network 432. A remote computerized system of the remote computerized systems 434 may be a vehicle, a server, or one or more computers having access to a storage system. The storage system accessible by the remote computerized systems 434 may store road segment information, safe segment metadata, or other data associated with determination of safe road segments. The communication system 430 may comprise a network interface controller supporting Ethernet communication at 1 gigabit per second, 10 gigabits per second, 25 gigabits per second, or 100 gigabits per second. The communication system 430 may also comprise a wireless network interface controller supporting Wi-Fi communication according to IEEE 802.11ax or IEEE 802.11be standards. The network 432 may comprise a local area network, a wide area network, or the Internet. The communication link 436 may comprise a peripheral component interconnect express bus, a universal serial bus, or a Thunderbolt interface.

The computerized system 400 may be a server, a laptop, a desktop, or any other computer. The computerized system 400 may include or be in communication with a sensing unit. The computerized system 400 may include or be in communication with a controller. The man machine interface 440 may provide interaction between the computerized system 400 and a user for configuration of lane pilot parameters or review of safe road segment determinations. The man machine interface 440 may comprise a display device such as a liquid crystal display, an organic light-emitting diode display, or a cathode ray tube display. The man machine interface 440 may also comprise input devices such as a keyboard, a mouse, a trackpad, a touchscreen, or a voice input device. The man machine interface 440 may implement a graphical user interface presenting visualizations of safe road segment data, training progress metrics, and model performance statistics.

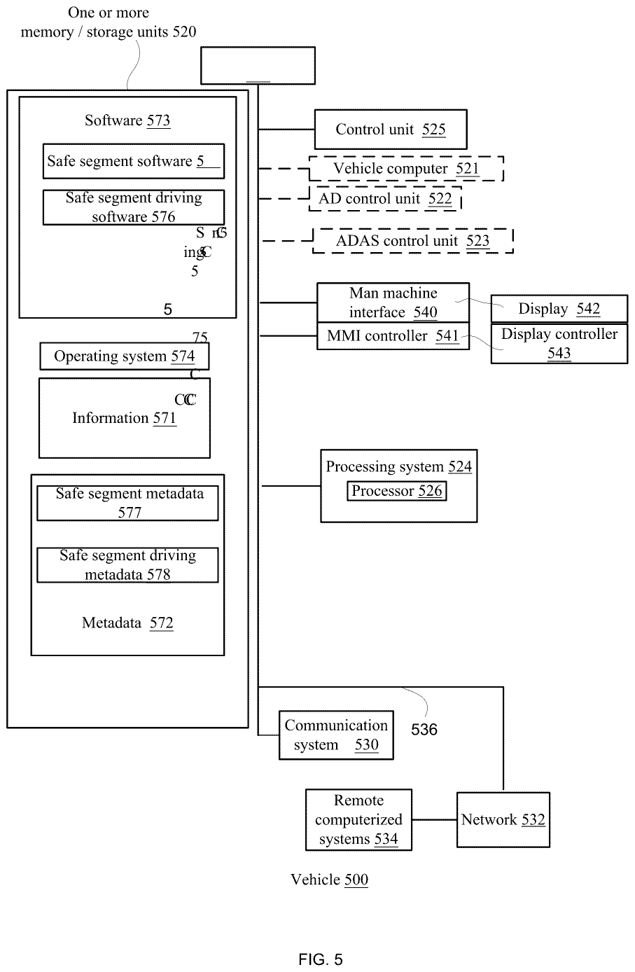

Referring to FIG. 5, a vehicle 500 configured to selectively apply lane pilot functionality for autonomous driving is illustrated. The vehicle 500 may include a sensing system 510 that captures environmental data relevant to driving operations. The sensing system 510 may obtain sensed information pertaining to real time driving scenarios including road conditions, driving behavioral information of road players in a road lane, environmental information, road players in the road lane, road barriers, hazards, and anomalies. The sensing system 510 may comprise a plurality of cameras including forward-facing cameras, rear-facing cameras, side-facing cameras, and surround-view cameras configured to capture visual imagery of the vehicle environment. The cameras may include monocular cameras, stereo cameras, or multi-focal cameras with different focal lengths for near-field and far-field perception. The sensing system 510 may also comprise radar sensors including short-range radar sensors operating at 24 GHz and long-range radar sensors operating at 77 GHz configured to detect objects and measure object range, velocity, and angle. The sensing system 510 may further comprise lidar sensors configured to emit laser pulses and measure time-of-flight to generate three-dimensional point cloud representations of the vehicle environment. The sensing system 510 may additionally comprise ultrasonic sensors configured to detect nearby objects during low-speed maneuvering operations.

The vehicle 500 may include one or more memory/storage units 520 that store various software and data components for vehicle operation. The memory/storage units 520 may store software 573, which may include safe segment software 575 for identifying safe road segments and safe segment driving software 576 for applying lane pilot functionality while driving through safe road segments. The safe segment software 575 may verify the safety of a safe road segment. The safe segment software 575 may evaluate the safety of unmapped road segments. The safe segment driving software 576 may function as a safe road segment driving module that may be selectively activated or deactivated based on verification results. The memory/storage units 520 may comprise automotive-grade storage devices designed to operate reliably in harsh environmental conditions including temperature extremes ranging from −40 degrees Celsius to 85 degrees Celsius, high humidity, and mechanical vibration. The memory/storage units 520 may implement wear leveling algorithms to extend the operational lifespan of flash memory cells.

With continued reference to FIG. 5, the memory/storage units 520 may also store an operating system 574, information 571, and metadata 572. The metadata 572 may include safe segment metadata 577 used by the safe segment software 575 and safe segment driving metadata 578 used by the safe segment driving software 576. The safe segment metadata 577 may contain data structures storing road segments that are deemed to be safe for autonomous driving. The safe segment driving metadata 578 may contain parameters and configurations for lane pilot operations during safe road segment traversal. The operating system 574 may comprise a real-time operating system such as QNX, VxWorks, or AUTOSAR configured to provide deterministic task scheduling and bounded interrupt latency for safety-critical vehicle control operations. The operating system 574 may implement memory protection mechanisms to isolate safety-critical software components from non-safety-critical software components.

The vehicle 500 may include a control unit 525 that manages various control functions. The control unit 525 may cooperate with a vehicle computer 521 configured to control the operation of the vehicle including an engine, a transmission, and other vehicle systems. The vehicle computer 521 may be in communication with an engine control module, a transmission control module, a powertrain control module, and the like. The control unit 525 may also cooperate with an AD control unit 522 configured to control autonomous driving operations and an ADAS control unit 523 configured to control advanced driver assistance system operations. The control unit 525 may control or communicate with other vehicle components including the vehicle computer 521. The control unit 525 may comprise an electronic control unit implemented using a microcontroller or microprocessor with integrated analog-to-digital converters, digital-to-analog converters, pulse-width modulation outputs, and communication interfaces. The AD control unit 522 may comprise a high-performance computing platform including multiple system-on-chip devices, each system-on-chip device integrating central processing unit cores, graphics processing unit cores, neural processing unit cores, and hardware accelerators for sensor data processing. The ADAS control unit 523 may comprise a domain controller configured to execute advanced driver assistance functions including adaptive cruise control, lane keeping assist, automatic emergency braking, and blind spot monitoring.

As further shown in FIG. 5, a man machine interface 540 may provide interaction between the vehicle 500 and a user. The man machine interface 540 may include an MMI controller 541 that manages interface operations. The man machine interface 540 may also include a display 542 and a display controller 543 that controls the display 542. A computerized system of the vehicle 500 may output, via the man machine interface 540, an indication when the safe segment driving software 576 functioning as the safe road segment driving module is selectively activated. The display 542 may present visual indications to a driver regarding activation status of the lane pilot functionality. The display 542 may comprise an instrument cluster display positioned behind the steering wheel, a center console display positioned in the center of the dashboard, or a head-up display projecting information onto the windshield. The display 542 may implement a liquid crystal display panel, an organic light-emitting diode display panel, or a micro-LED display panel with high brightness and wide viewing angles suitable for automotive applications. The display controller 543 may comprise a graphics processing unit configured to render user interface elements, navigation maps, and status indicators at frame rates exceeding 60 frames per second. The MMI controller 541 may process input from touch sensors, rotary encoders, physical buttons, and voice recognition systems to enable driver interaction with the man machine interface 540.

A processing system 524 including a processor 526 may execute the software 573 stored in the memory/storage units 520 to perform safe road segment identification and verification operations. The processing system 524 may implement an artificial intelligence model for autonomous driving in compliance with one or more levels of autonomous driving such as L2, L2+, L2++, L3, or L4 autonomous driving. A communication system 530 may enable the vehicle 500 to communicate with external systems via a communication link 536. The communication link 536 may connect to a network 532, which may provide connectivity to remote computerized systems 534. The remote computerized systems 534 may include servers or computers having access to storage systems containing road segment information and other data relevant to safe road segment determination. The processor 526 may comprise an automotive-grade system-on-chip integrating ARM Cortex-A processing cores, ARM Cortex-R processing cores for real-time operations, and dedicated neural network accelerator cores. The processor 526 may operate at clock frequencies ranging from 1 GHz to 3 GHz and may implement dynamic voltage and frequency scaling to optimize power consumption based on computational load. The communication system 530 may comprise a telematics control unit integrating cellular modem, Wi-Fi transceiver, Bluetooth transceiver, and global navigation satellite system receiver. The cellular modem may support 4G LTE and 5G NR communication standards for high-bandwidth data transfer and low-latency vehicle-to-network communication. The communication link 536 may comprise a controller area network bus, a local interconnect network bus, an Ethernet network, or a FlexRay network for in-vehicle communication between electronic control units.

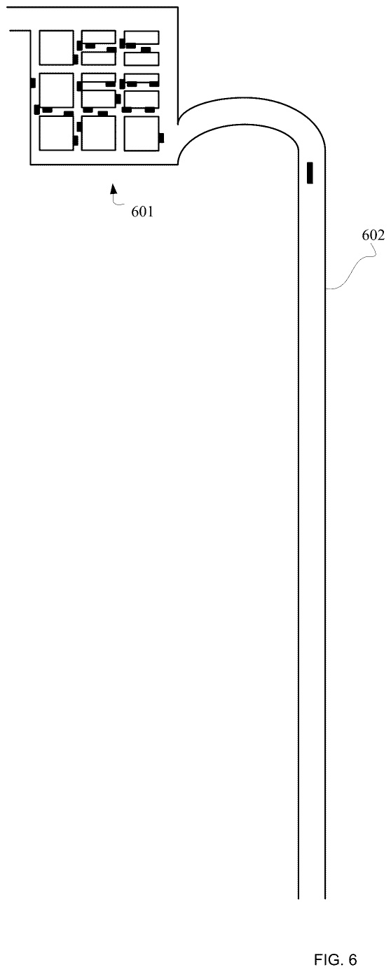

Referring to FIG. 6, a dense urban region 601 and a highway straight lane 602 are illustrated. The dense urban region 601 is shown in an upper left portion of FIG. 6 and includes a grid-like arrangement of buildings or structures represented by rectangular shapes with various internal markings. The highway straight lane 602 extends vertically downward from the dense urban region 601, connected by a curved transition section. The highway straight lane 602 is depicted as a long, narrow, straight roadway with parallel lane markings.

The dense urban region 601 represents a complex environment that may not be deemed safe for autonomous driving operations by the Lane Pilot system. The grid-like arrangement of structures in the dense urban region 601 may present multiple potential hazards including pedestrian crossings, intersections, traffic signals, and unpredictable movements of road users. The complexity of the dense urban region 601 may exceed a specified complexity threshold used as a metric for determining whether a road segment qualifies as safe for autonomous driving operations. Road segments within the dense urban region 601 may require human driver attention due to the elevated risk associated with the complex environment.

With continued reference to FIG. 6, the highway straight lane 602 represents a simpler environment that may be deemed safe for autonomous driving operations by the Lane Pilot system. The parallel lane markings of the highway straight lane 602 indicate a substantially straight lane with low curvatures. The highway straight lane 602 may have a complexity below the specified complexity threshold. The highway straight lane 602 may be associated with a risk below a specified risk threshold. Road segments along the highway straight lane 602 may be suitable for the Lane Pilot system to operate during intervention-free moments.

The contrast between the dense urban region 601 and the highway straight lane 602 illustrates the distinction between road segments suitable for the Lane Pilot system and road segments requiring human driver attention. The computerized system 400 or the vehicle 500 may classify road segments similar to the highway straight lane 602 as safe road segments stored in a data structure. The computerized system 400 or the vehicle 500 may exclude road segments similar to the dense urban region 601 from classification as safe road segments. The safe segment software 575 may use the safe segment metadata 577 to distinguish between road segments having characteristics of the dense urban region 601 and road segments having characteristics of the highway straight lane 602.

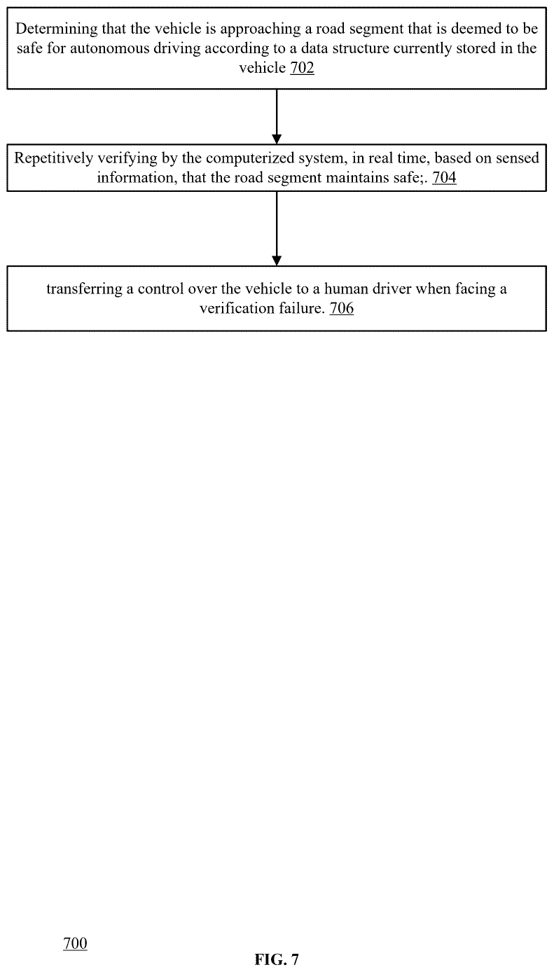

Referring to FIG. 7, a method 700 for selective autonomous driving during inference is illustrated. Method 700 may be performed by a computerized system of a vehicle to enable intervention-free autonomous driving operations along road segments that have been determined to be safe. Method 700 may be executed by the processing system 524 of the vehicle 500 while the processor 526 executes the safe segment software 575 and the safe segment driving software 576. Method 700 may operate as a continuous loop during vehicle operation, with each iteration of the loop corresponding to a verification cycle for the current road segment.

Method 700 begins at step 702, where the computerized system determines that the vehicle is a road segment that is deemed to be safe for autonomous driving according to a data structure currently stored in the vehicle. Approaching-for example is about 1-30 seconds from the road segment. The data structure may contain road segments that have been previously evaluated and classified as safe. The road segment may be deemed to be safe based on multiple metrics. The multiple metrics may comprise a machine learning generated metric and a statistical metric. The multiple metrics may comprise at least one of general-purpose metrics, system-specific metrics, driving related metrics, road related metrics, environmental metrics, and key performance indicators. The multiple metrics may comprise one or more metrics related to durations of non-interrupted autonomous driving sessions over the road segment. The determination at step 702 may be performed by a segment lookup module configured to query the data structure using the current vehicle position and heading as search parameters. The segment lookup module may implement spatial indexing techniques to efficiently locate road segments that intersect with the projected vehicle trajectory.

With continued reference to FIG. 7, method 700 proceeds to step 704, where the computerized system repetitively verifies, in real time, based on sensed information, that the road segment maintains safe. The sensed information may comprise at least one of road condition information, driving behavioral information of road players in a road lane, environmental information, and information pertaining to road barriers and hazards. The verifying may be based on real time conditions related to the road segment. The real-time conditions may comprise at least one of weather conditions, road hazards, road barriers, anomalies on the road, and unexpected lane merges or lane splits. The verification at step 704 may be performed by a real-time verification module configured to process sensor data streams from the sensing system 510 and evaluate safety conditions at each verification cycle. The real-time verification module may implement parallel processing pipelines for different sensor modalities, with a fusion stage that combines verification results from each pipeline to generate a final safety determination. The real-time verification module may utilize hardware accelerators such as neural processing units or field-programmable gate arrays to achieve the computational throughput required for real-time operation.

Method 700 continues to step 706, where the computerized system transfers control over the vehicle to a human driver when facing a verification failure. Prior to the transition, the computerized system may issue a predictive indication notification to the human driver. The computerized system may selectively deactivate a safe road segment driving module upon the transition. The computerized system may output, via a man machine interface, an indication when the safe road segment driving module is selectively activated. The control transfer at step 706 may be managed by a transition controller configured to coordinate the handoff of vehicle control authority from the AD control unit 522 to the human driver. The transition controller may monitor driver readiness indicators including steering wheel grip force, accelerator pedal position, brake pedal position, and driver gaze direction to confirm that the driver is prepared to assume control. The transition controller may implement a fallback strategy that maintains vehicle control in a safe state if the driver fails to assume control within a specified time period.

As further shown in FIG. 7, method 700 may include step 708, where the computerized system populates the data structure by evaluated road segments that are found to be safe by applying multiple metrics, and by similar road segments that are found by training a machine learning model to provide road segments deemed to be safe. The training may comprise applying a semi-supervised learning process that matches the evaluated road segments against additional road segments to identify clusters of safe road segments. The data structure population at step 708 may be performed by a data structure update module configured to receive safe road segment classifications from the computerized system 400 and integrate the classifications into the local data structure stored in the memory/storage units 520. The data structure update module may implement incremental update algorithms that efficiently merge new road segment data with existing data without requiring a complete rebuild of the data structure. The data structure update module may also implement version control mechanisms to track changes to the data structure over time and enable rollback to previous versions if necessary.

A number of implementations have been described. Nevertheless, it will be understood that various modifications may be made without departing from the spirit and scope of the disclosure. Accordingly, other implementations are within the scope of the following claims.

A number of implementations have been described. Nevertheless, it will be understood that various modifications may be made without departing from the spirit and scope of the disclosure. Accordingly, other implementations are within the scope of the following claims.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

The different figures illustrates examples of units and/or software and/or information items and/or steps and/or components. These examples are provided for brevity of explanation. At least one of the units and/or software and/or information items and/or steps and/or components is optional or mandatory.

One or more method steps may be executed by artificial intelligence entities and/or a machine learning entity. A behavioral agent may be an artificial intelligence entity.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference to an artificial intelligence model should be applied mutatis mutandis to an artificial intelligence process.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

A number of implementations have been described. Nevertheless, it will be understood that various modifications may be made without departing from the spirit and scope of the disclosure. Accordingly, other implementations are within the scope of the following claims.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

1. A method for selective autonomous driving during inference, method comprising:
determining, by a computerized system of the vehicle that the vehicle is approaching a road segment that is deemed to be safe for autonomous driving according to a data structure currently stored in the vehicle;
repetitively verifying by the computerized system, in real time, based on sensed information, that the road segment maintains safe; and
transferring a control over the vehicle to a human driver when facing a verification failure.

2. Method according to claim 1, wherein the verifying is based on real time conditions are related to the road segment.

3. Method of claim 2, wherein the real-time conditions comprise at least one of weather conditions, road hazards, road barriers, anomalies on the road, and unexpected lane merges or lane splits.

4. Method according to claim 1, wherein the road segment is deemed to be safe based on multiple metrics.

5. Method according to claim 4, wherein the multiple metrics comprise a machine learning generated metric and a statistical metric.

6. Method according to claim 4, wherein the multiple metrics comprise at least one of general-purpose metrics, system-specific metrics, driving related metrics, road related metrics, environmental metrics, and key performance indicators.

7. Method according to claim 4, wherein the multiple metrics comprise one or more metrics related to durations of non-interrupted autonomous driving sessions over the road segment.

8. Method of claim 1, further comprising issuing, by the computerized system, a predictive indication notification to the human driver prior to the transition, and selectively deactivating a safe road segment driving module upon the transition.

9. Method of claim 8, further comprising outputting, by the computerized system via a man machine interface, an indication when the safe road segment driving module is selectively activated.

10. Method of claim 1, wherein the sensed information comprises at least one of road condition information, driving behavioral information of road players in a road lane, environmental information, and information pertaining to road barriers and hazards.

11. Method according to claim 1, further comprising populating the data structure by (a) evaluated road segments that are found to be safe by applying multiple metrics, and (b) similar road segments that are found by training a machine learning model to provide road segments deemed to be safe, wherein the training comprises applying a semi-supervised learning process that matches the evaluated road segments against additional road segments to identify clusters of safe road segments.

12. A non-transitory computer readable medium storing instructions that, when executed by a processor, cause the processor to perform a method for selective autonomous driving during inference, method comprising: determining that a vehicle is approaching a road segment that is deemed to be safe for autonomous driving according to a data structure currently stored in the vehicle; repetitively verifying, in real time, based on sensed information, that the road segment maintains safe; and transferring a control over the vehicle to a human driver when facing a verification failure.

13. The non-transitory computer readable medium according to claim 12, wherein the verifying is based on real time conditions related to the road segment.

14. The non-transitory computer readable medium of claim 13, wherein the real-time conditions comprise at least one of weather conditions, road hazards, road barriers, anomalies on the road, and unexpected lane merges or lane splits.

15. The non-transitory computer readable medium according to claim 12, wherein the road segment is deemed to be safe based on multiple metrics.

16. The non-transitory computer readable medium according to claim 15, wherein the multiple metrics comprise a machine learning generated metric and a statistical metric.

17. The non-transitory computer readable medium according to claim 15, wherein the multiple metrics comprise at least one of general-purpose metrics, system-specific metrics, driving related metrics, road related metrics, environmental metrics, and key performance indicators.

18. The non-transitory computer readable medium according to claim 15, wherein the multiple metrics comprise one or more metrics related to durations of non-interrupted autonomous driving sessions over the road segment.

19. The non-transitory computer readable medium of claim 12, wherein method further comprises issuing a predictive indication notification to the human driver prior to the transition, and selectively deactivating a safe road segment driving module upon the transition.

20. The non-transitory computer readable medium of claim 12, wherein the sensed information comprises at least one of road condition information, driving behavioral information of road players in a road lane, environmental information, and information pertaining to road barriers and hazards.
